(19) United States
(12) Patent Application Publication
(10) Pub. No.: US 2010/0300384 A1
(43) Pub. Date: Dec. 2, 2010

(54) CRANKCASE CAST IN ONE PIECE FOR A MULTI-CYLINDER ENGINE

(76) Inventor: Erich Eder, Neuhaus/Inn (DE)

Correspondence Address: KATTEN MUCHIN ROSENMAN LLP, 575 MADISON AVENUE, NEW YORK, NY, 10022-2585, US

(21) Appl. No.: 12/600,100

(22) PCT Filed: Jun. 18, 2008
(86) PCT No.: PCT/EP2008/004892

§ 371 Date: Nov. 13, 2009

(30) Foreign Application Priority Data
Jun. 20, 2007 (DE) 10 2007 028 186.4

(51) Int. Cl. F02B 75/18; F02F 7/00

(52) U.S. Cl. 123/52.1; 123/195 R

(57) ABSTRACT

A crankcase (1, 1′) cast in one piece for a multi-cylinder engine (16), particularly for a multi-cylinder diesel engine, comprising a holder (2) for a horizontally extending crankshaft and a plurality of cylinder bores (3), the crankcase on the bottom thereof comprising a completely peripheral, uninterrupted flange (5, 5′) for attaching an oil pan (17), is characterized in that the crankcase (1, 1′) is fully enclosed on the control side (7) thereof opposite the flywheel side, with the exception of a bore (8) for receiving an end of the crankshaft, wherein the diameter of the bore (8) is dimensioned such that the crankshaft can be introduced through the opening surrounded by the flange (5, 51) into the bore (8) in an inclined position when mounting the engine and can then be positioned within the bearing blocks (13) in the horizontal position.

The present invention relates to a crankcase cast in one piece, for a multi-cylinder engine, particularly a multi-cylinder diesel engine, having an accommodation for a crankshaft that runs horizontally, as well as multiple cylinder bores.

Such crankcases are widespread in the state of the art. The crankshaft to be inserted into the crankcase is usually inserted into the crankcase, which is open on the underside, from below, in a horizontal position, and is equipped, on the so-called flywheel side of the crankcase, at one of its shaft ends, with a flywheel that reduces the rotational vibrations of the crankshaft. The side of the crankcase that lies opposite the flywheel side is referred to as the control side, and usually has an open contour, i.e. large-area openings or perforations. To cover them, in the state of the art, a separate control lid that is to be affixed to the crankcase on the control side is provided. Below the crankcase and the control lid that follows it laterally, an oil pan for accommodating the oil sump is usually provided, for which purpose corresponding flange sections for affixing and sealing the oil pan are provided on the underside of crankcase and control lid. In this connection, it proves to be particularly problematical to seal the oil pan in the region of transition sections of the individual flange sections, particularly, however, in the region in which oil pan, crankcase, and control lid meet one another at a T-like joining surface. This so-called T-join seal not only tends to leak, but is also expensive and complicated to seal. Further sealing problems frequently occur also at those locations of the crankcase at which other separate engine units are attached.

Furthermore, crankcases of the type stated initially are already known from DE 10024208 A1 and from JP 2004-316574 A, which have a completely circumferential, uninterrupted flange on their underside, for attaching the oil pan. According to DE 10024208 A1, noise emissions are supposed to be reduced in this way. According to JP 2004-316574 A, it is supposed to be possible to use a liquid injectable sealant in this way, and to reduce the number of connection screws required. However, despite all this, there are problems in the assembly of a crankshaft within the crankcase, and for this reason, JP 2004-316574 A provides a special intermediate frame on which the aforementioned flange is configured, and which is only installed after installation of the crankshaft. Suitable means, by means of which a one-part crankshaft that projects beyond the clear width of the opening formed by the flange in its later horizontal position can be installed, are not disclosed.

Proceeding from the state of the art as explained above, it is the task of the present invention to make available a crankcase cast in one piece, of the type stated initially, with which a simpler method of construction of the multi-cylinder engine to be equipped with it is made possible, with simultaneous cost savings, whereby in particular, the sealing problems explained above are supposed to be avoided, and a low assembly effort is supposed to be guaranteed.

This task is accomplished with a crankcase of the type mentioned initially, according to claim 1.

The crankcase according to the invention, which has a completely circumferential, uninterrupted flange for attachment of the oil pan on its underside, is characterized in that the crankcase is completely closed on its control side that lies opposite the flywheel side, with the exception of a bore for accommodating one end of the crankshaft, whereby the diameter of the bore is dimensioned in such a way that the crankshaft can be introduced into the bore through the opening enclosed by the flange, in a slanted position, during assembly of the engine, and then can be positioned in its horizontal position within the bearing blocks.

Because the connection between crankcase and oil pan takes place by means of an uninterrupted flange, particularly effective and reliable sealing of the crankcase relative to the oil pan can be implemented along a single sealing line that follows the circumferential flange.

According to the invention, it is furthermore provided that the crankcase is completely closed on its control side, with the exception of a single bore for accommodating one end of the crankshaft. In this way, it is possible to do without a separate control housing on the control side of the crankcase, and this brings with it not insignificant cost savings. A seal between a control housing and the crankcase and/or the oil pan, of whatever kind, is not required, because there is no control housing.

As a result of the flange that runs around the entire circumference on the underside of the crankcase, particular measures are taken, within the scope of the invention, which allow insertion of the crankshaft in its accommodation in the crankcase during assembly of the engine.

For reasons of stability, the use of a crankshaft produced in one piece is aimed at, and it is provided, according to the invention, that the bore in the crankcase provided on the control side is dimensioned, in its diameter, in such a way that the crankshaft can be passed into and through the bore with its shaft end, and then positioned in its horizontal position within the bearing blocks. In this connection, the crankshaft must be brought into a slanted position for installation purposes, because the clear width of the opening formed by the flange, on the underside of the crankcase, is not sufficient for the crankshaft to be passed through this opening vertically, in its horizontal orientation.

It is evident that suitable measures in dimensioning the crankshaft accommodation on the flywheel side—which usually functions as the main power take-off side—are preferably also provided. On the flywheel side, the crankshaft is equipped with a flywheel that serves as a counterweight and, in usual manner, with a gear wheel for the power take-off side. In this connection, it is advantageous that, for one thing, the counterweight contour and the accommodation in the crankcase that corresponds to it, and, for another thing, the gear wheel that might also be accommodated in the crankcase, and the accommodation that corresponds to it, are configured or dimensioned in such a manner that pivoting of the crankshaft, with the flywheel and gear wheel mounted on it, from the slanted position that is required for assembly purposes, into the horizontal end position, is made possible. For this purpose, it is obvious that it must be possible to guide the crankshaft plus attachments past the bearing blocks provided in the crankcase, without touching them, and this is to be ensured by means of a corresponding configuration of the accommodations provided in the crankcase.

It also proves to be particularly advantageous if the flange makes available a sealing line between crankcase and oil pan that runs—essentially or precisely—in one plane, which can be sealed in particularly simple manner. This plane is preferably horizontal and thus oriented parallel to the crankshaft axis.

In the embodiment of a crankcase without a control lid, according to the invention, attention must be paid to ensure that the crankshaft is mounted within the bore in the crankcase in suitable manner. For this purpose, it is advantageous to use a bearing ring that encloses the crankshaft within the bore.

Particularly preferably, in a crankcase according to the invention, it can furthermore be provided that the crankshaft to be used in it makes available a power take-off possibility on both side, in other words on the control side and the flywheel side. On the control side, where the crankshaft is mounted in the aforementioned bore of the crankcase, it is particularly possible to think of a drive of the oil pump of the engine to be affixed outside of the crankcase, in this connection. Sealing of the opening provided in the crankcase for passing the crankshaft through can preferably be implemented, in this connection, in that the crankcase makes available a sealing surface that completely encloses the bore, on its circumference, on the outside, against which a corresponding sealing surface of the pump housing of the oil pump driven by the crankshaft lies in sealed manner.

Of course, the same applies analogously for the case that a different engine unit other than an oil pump is to be drivable on the control side. Here again, it can be provided analogously that the housing of the engine unit to be affixed to the crankcase from the outside interacts with a sealing surface that runs around the complete circumference of the bore, on the crankcase, to form a seal.

Finally, in the case of a crankcase according to the invention, it can supplementally be provided that the crankcase cast in one piece also forms the housing of an exhaust gas reflux cooler, thereby making it possible to avoid other seals required in the state of the art relative, to a housing of a commercially available exhaust gas reflux cooler that would otherwise be separately produced and affixed. Furthermore, the required connection of the exhaust gas reflux cooler to the cooling fluid circuit of the engine can then take place by means of water channels completely integrated into the crankcase that is cast in one piece. The partial stream of the total exhaust gas that is to be cooled—depending on the engine design—can be guided in a stainless steel pipe, in this connection, which is connected with the exhaust gas exit of the engine, passed though the crankcase that forms the housing of the exhaust gas reflux cooler, and has cooling water flowing over it. Thus, particularly effective exhaust gas reflux cooling can furthermore be implemented, since no partial stream of the cooling water has to be branched off to a separate exhaust gas reflux cooler and passed back again, in this connection, but rather, preferably the entire cooling water amount can be passed through the exhaust gas reflux cooler integrated into the crankcase, immediately after exiting from the water pump.

The present invention furthermore relates not only to a crankcase of the type explained above, but also to a multi-cylinder (diesel) engine having a crankcase of the type explained above.

In the following, the invention will be explained in greater detail using an exemplary embodiment shown in the drawing.

This shows:

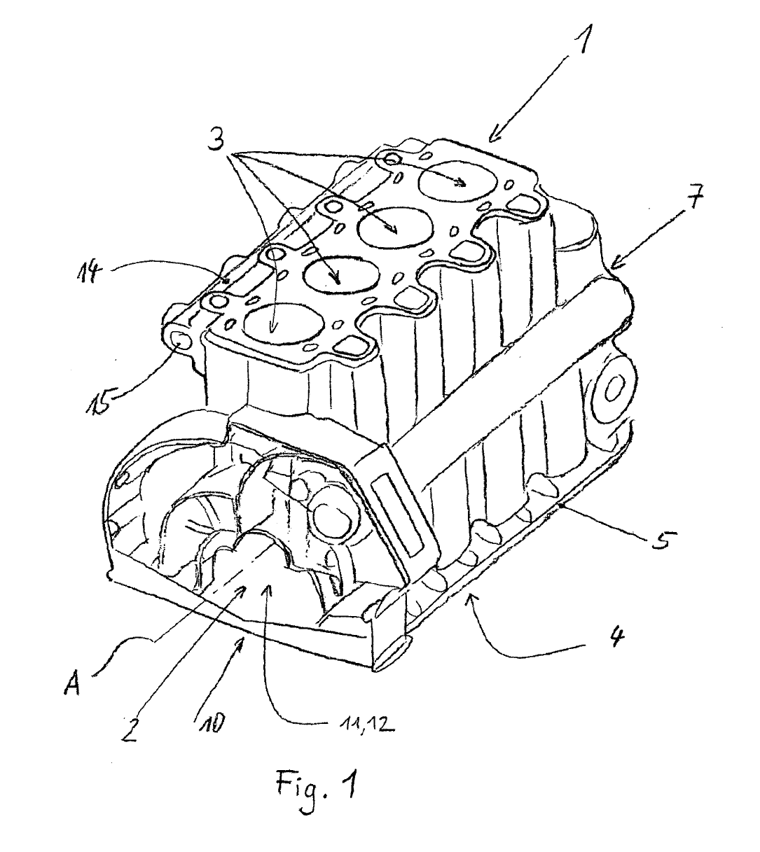

FIGS. 1-3 an exemplary embodiment of a crankcase according to the invention, from different perspectives, and

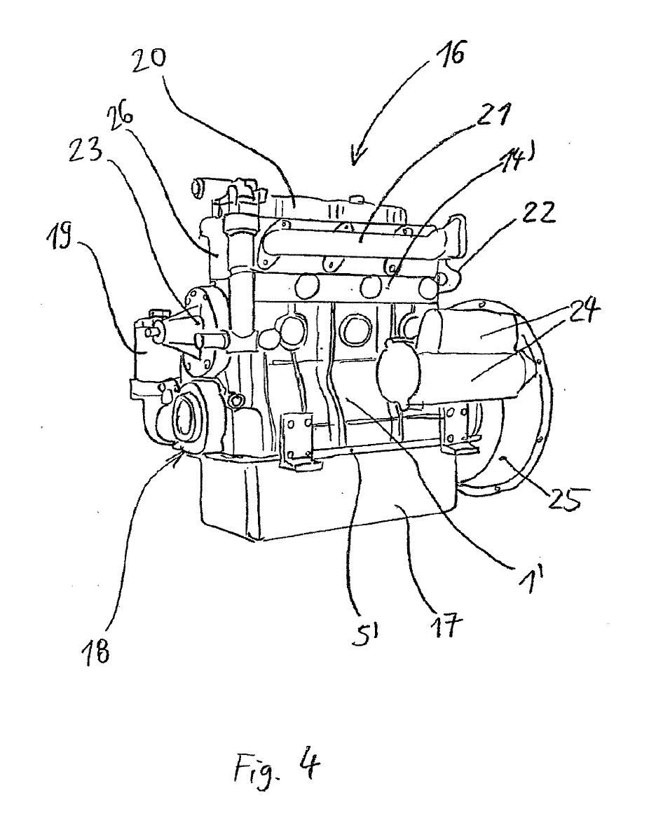

FIG. 4 an exemplary embodiment of a diesel engine according to the invention, with a crankcase according to the invention.

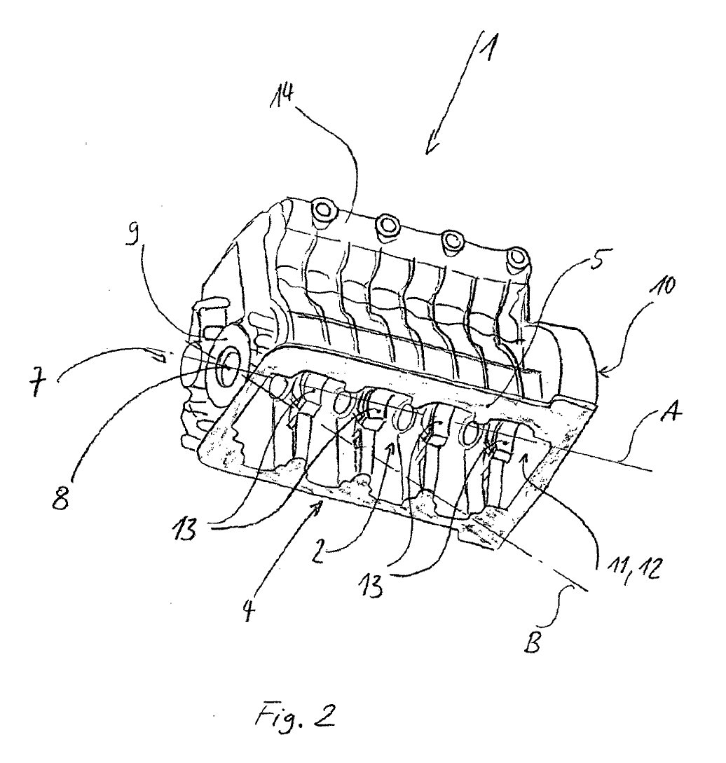

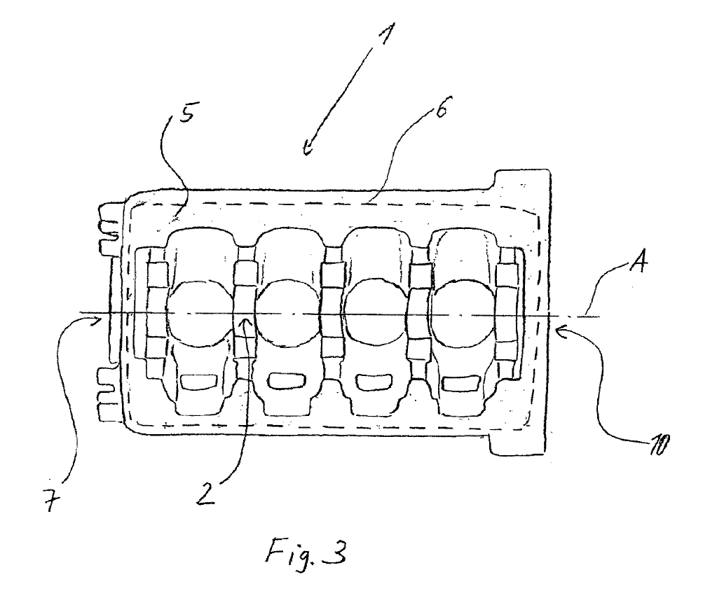

The crankcase 1 shown in FIGS. 1 to 3 from different perspectives, namely in FIG. 1 at a slant from above, from the view of the flywheel side, in FIG. 2 at a slant from below, from the view of the control side, and in FIG. 3 from below, is cast in one piece and intended for a four-cylinder diesel engine. The crankcase 1 comprises an accommodation 2 for a crankshaft (not shown) that runs horizontally along the axis A, and a total of four cylinder bores 3. On its underside 4, the crankcase is configured with a completely circumferential, uninterrupted flange 5 for attaching an oil pan, so that the oil pan—not shown in FIGS. 1 to 3—can be mounted on the crankcase along the flange 5, attached to it by means of suitable attachment means, and sealed against the crankcase 1 along a circumferential sealing line 6 (shown with a broken line in FIG. 2). The sealing line 6 runs in a precisely horizontal plane, together with the flange 5. On the control side 7, the crankcase 1 is completely closed, with the exception of a bore 8 that accommodates one end of the crankshaft, so that it is possible to do without a separate control housing. The bore 8 is completely surrounded on its circumference by a sealing surface 9 of the crankcase 1, with which a sealing surface of the housing of an oil pump (not shown in FIGS. 1 to 3) driven by the control side end of the crankshaft interacts, forming a seal. The flywheel side 10 of the crankcase 1 that lies opposite the control side 7 serves as the main power take-off side of a diesel engine equipped with the crankcase 1 according to the invention. The accommodation 2 provided for the crankshaft 1 therefore lies adjacent, on the flywheel side, to corresponding accommodations 11, 12 for the flywheel and the power take-off gear wheel (both not shown).

The bore 8 on the control side 7 of the crankcase 1 has a larger diameter than the crankshaft, so that the crankshaft can be introduced into the bore 8 with its control-side shaft end, in a slanted position along the axis B shown in FIG. 2—through the opening formed by the flange 6 on the underside of the crankcase 1—and subsequently can be pivoted—without contact—into its horizontal position within the bearing blocks 13, according to axis A. Subsequently, a suitable bearing ring is installed between crankshaft and bore 8. Aside from the crankshaft and its accommodation 2 within the bearing blocks 13, the flywheel and the power take-off side gear wheel and the accommodations 11, 12 intended for them are also dimensioned in such a way that the pivoting movement required for installing and removing the crankshaft can be carried out.

Finally, on the side of the crankcase 1, the housing 14 of an exhaust gas reflux cooler, cast on in one piece with the crankcase 1, is also provided, into which a stainless steel pipe (not shown) is introduced through a bore 15 to be provided on the flywheel side, parallel to the crankshaft axis A, which pipe then has cooling water flowing around it within the housing 14.

FIG. 4, finally, shows a partially assembled three-cylinder diesel engine 16, which is equipped with a crankcase 1′ according to the invention, in a perspective view. Since the crankcase 1′, with the exception of the number of cylinders, agrees with the crankcase 1 from FIGS. 1 to 3 in the essential characteristics of the invention, reference is made, in this regard, to the explanations in connection with the exemplary embodiment of the crankcase 1 according to the invention, in accordance with FIGS. 1 to 3.

In the diesel engine 16 from FIG. 4, an oil pan 17 is installed on the underside of the crankcase 1′, which pan is sealed against a completely circumferential, uninterrupted flange 5′ of the crankcase 1′ that runs in a horizontal plane. On the control side of the diesel engine 16, in the region of the bore for the crankshaft—not visible here—an oil pump 18 operated by the crankshaft is installed, which is sealed on its housing with a circumferential sealing surface, against a sealing surface of the crankcase 1′. Furthermore, the oil filter 19 is also installed on the control side. A cylinder head 26 whose valve drive is closed off by a cylinder head cover 20 is screwed onto the top of the crankcase. From the exhaust gas that flows from the exhaust gas outlet channels of the individual cylinders through the exhaust gas manifold 21, in the direction of the exhaust pipe, a partial stream of the exhaust gas is branched off by means of the exhaust gas tapping line 22. The exhaust gas tapping line 22 is connected with a steel pipe that runs within the housing 14′ of the exhaust gas reflux cooler. The cooling water for the exhaust gas reflux cooler flows into the housing 14′ immediately after exiting from the water pump 23 flanged onto the crankcase 1′ on the control side. Furthermore, a starter 24 and a connection housing 25 that is usual for industrial diesel engines are affixed to the crankcase 1′.

1-6. (canceled)

7. Crankcase (1, 1′) cast in one piece, for a multi-cylinder engine (16), particularly a multi-cylinder diesel engine, having an accommodation (2) for a crankshaft that runs horizontally, as well as multiple cylinder bores (3), which has a completely circumferential, uninterrupted flange (5, 5′) on its underside, for installation of an oil pan (17), characterized in that the crankcase (1, 1′) is completely closed on its control side (7) that lies opposite the flywheel side, with the exception of a bore (8), whereby the diameter of the bore (8) is dimensioned in such a way that the crankshaft can be introduced into the bore (8) through the opening enclosed by the flange (5, 5′), in a slanted position, during assembly of the engine, and then can be positioned in its horizontal position within the bearing blocks (13).

8. Crankcase (1, 1′) according to claim 7, characterized in that
the flange (5, 5′) makes available a sealing line (6) between crankcase (1, 1′) and oil pan (17) that runs in one plane.

9. Crankcase (1, 1′) according to claim 7, characterized in that
the crankcase (1, 1′) has a sealing surface (9) on the outside, which surrounds the bore (8) on the control side (7) over its complete circumference, to interact with a corresponding sealing surface of the housing of an engine unit, particularly an oil pump (18), to be affixed to the crankcase (1, 1′).

10. Crankcase (1, 1′) according to claim 7, characterized in that
a housing (14, 14′) of an exhaust gas reflux cooler configured in one piece with the crankcase (1, 1′) is integrated into the latter.

11. Multi-cylinder engine, particularly diesel engine, having a crankcase (1, 1′) cast in one piece, for a multi-cylinder engine (16), particularly a multi-cylinder diesel engine, having an accommodation (2) for a crankshaft that runs horizontally, as well as multiple cylinder bores (3), which has a completely circumferential, uninterrupted flange (5, 5′) on its underside, for installation of an oil pan (17), characterized in that the crankcase (1, 1′) is completely closed on its control side (7) that lies opposite the flywheel side, with the exception of a bore (8), whereby the diameter of the bore (8) is dimensioned in such a way that the crankshaft can be introduced into the bore (8) through the opening enclosed by the flange (5, 5′), in a slanted position, during assembly of the engine, and then can be positioned in its horizontal position within the bearing blocks (13).
